(19) United States
(12) Patent Application Publication
(10) Pub. No.: US 2023/0342914 A1
(43) Pub. Date: Oct. 26, 2023

(54) METHOD AND SYSTEM FOR MONITORING A PATIENT EMOTIONAL STATE AND SEGMENTING OBTAINED EMISSION DATA BASED ON THE PATIENT EMOTIONAL STATE DATA

(71) Applicant: CANON MEDICAL SYSTEMS CORPORATION, Tochigi (JP)

(72) Inventors: Karthikayan BALAKRISHNAN, Vernon Hills, IL (US); Kent C. BURR, Vernon Hills, IL (US); Manabu TESHIGAWARA, Otawara (JP); Jeffrey KOLTHAMMER, Vernon Hills, IL (US); Wenyuan QI, Vernon Hills, IL (US)

(73) Assignee: CANON MEDICAL SYSTEMS CORPORATION, Tochigi (JP)

(21) Appl. No.: 17/726,070

(22) Filed: Apr. 21, 2022

(51) Int. Cl. G06T 7/00; G06T 7/20; G06T 11/00

(52) U.S. Cl. CPC G06T 7/0012; G06T 7/20; G06T 11/008; G06T 2207/10104; G06T 2207/20084; G06T 2207/10048

(57) ABSTRACT

A method of generating an image, including: receiving, via a monitoring device, time-dependent data corresponding to a patient parameter; obtaining emission data representing radiation detected during a medical imaging scan; identifying time frames during the medical imaging scan to exclude from the obtained emission data, the identified time frames corresponding to a stressed emotional state for the patient based on the patient parameter; modifying the obtained emission data to exclude the emission data corresponding to the time frames corresponding to the stressed emotional state; and generating an emotional-state-corrected image based on the modified emission data excluding the emission data corresponding to the time frames corresponding to the stressed emotional state.

### FIELD OF THE INVENTION

This disclosure relates to a method and system for detecting patient emotional state during a medical imaging process, and in one embodiment, to a method and system for receiving time-dependent data corresponding to a patient parameter that is used to detect a stressed emotional state for the patient based on the patient parameter and generating an emotional state-corrected medical image that excludes imaging data corresponding to the time frames corresponding to the stressed emotional state.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Positron emission tomography (PET) is a functional imaging modality that is capable of imaging biochemical processes in humans or animals through the use of radioactive tracers. In PET imaging, a tracer agent is introduced into the patient to be imaged via injection, inhalation, or ingestion. After administration, the physical and bio-molecular properties of the agent cause it to concentrate at specific locations in the patient's body. The actual spatial distribution of the agent, the intensity of the region of accumulation of the agent, and the kinetics of the process from administration to its eventual elimination are all factors that may have clinical significance.

The most commonly used tracer for PET studies is fluorodeoxyglucose (FDG), which allows the study of glucose metabolism, a process that is up-regulated substantially in cancerous tissue. PET scans with FDG are increasingly being used for staging, restaging, and treatment monitoring for cancer patients with different types of tumors.

During this process, a tracer attached to the agent will emit positrons. When an emitted positron collides with an electron, an annihilation event occurs, wherein the positron and electron are combined. Most of the time, an annihilation event produces two gamma rays (at 511 keV) traveling at substantially 180 degrees apart.

The PET images can be affected by physiological patient motion which degrades the images qualitatively as well as quantitatively. Some particular types of motion can contribute to the image degradation: cardiac contraction, respiratory motion, and patient repositioning during the acquisition. In particular, respiratory motion can adversely affect both PET and CT acquisitions and contributes to greater displacement of objects being imaged as compared to cardiac contraction while also being difficult to correct for. Given that the acquisition time of PET is typically longer than the respiratory period, a region of focal tracer uptake can appear blurred, particularly if it is subject to respiratory motion of greater amplitude than the resolution of the PET scanner.

CT images can be typically acquired with a tube-rotation period which is significantly less than the respiratory period. However, as the duration of the entire CT scan is at best comparable with the respiratory period, various slices throughout the scan can be acquired at different phases of the respiratory cycle, which can result in distortion. Combined, these effects can result in a spatial mismatch between the PET and CT images, which can also degrade the accuracy of attenuation correction. Thus, a PET scanning system including additional methods of determining unwanted scan data corresponding to patient motion and distress is desired.

### SUMMARY

The present disclosure relates to an imaging system, including: processing circuitry configured to receive, via a monitoring device, time-dependent data corresponding to a patient parameter, obtain emission data representing radiation detected during a medical imaging scan, identify time frames during the medical imaging scan to exclude from the obtained emission data, the identified time frames corresponding to a stressed emotional state for the patient based on the patient parameter, modify the obtained emission data to exclude the emission data corresponding to the time frames corresponding to the stressed emotional state, and generate an emotional-state-corrected image based on the modified emission data excluding the emission data corresponding to the time frames corresponding to the stressed emotional state.

The disclosure additionally relates to a method of generating an image, including: receiving, via a monitoring device, time-dependent data corresponding to a patient parameter; obtaining emission data representing radiation detected during a medical imaging scan; identifying time frames during the medical imaging scan to exclude from the obtained emission data, the identified time frames corresponding to a stressed emotional state for the patient based on the patient parameter; modifying the obtained emission data to exclude the emission data corresponding to the time frames corresponding to the stressed emotional state; and generating an emotional-state-corrected image based on the modified emission data excluding the emission data corresponding to the time frames corresponding to the stressed emotional state.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of an imaging system, according to an embodiment of the present disclosure.

FIG. 2A is a schematic of the determination of a patient comfort level, according to an embodiment of the present disclosure.

FIG. 2B is a schematic of a scan length adjustment in response to a paused scan, according to an embodiment of the present disclosure.

FIG. 2C is a schematic of a R-R histogram, according to an embodiment of the present disclosure.

FIG. 3 shows a non-limiting example of a flow chart for a method of generating an image, according to an embodiment of the present disclosure.

FIG. 4A shows an example of a general artificial neural network (ANN) having N inputs, K hidden layers, and three outputs, according to an embodiment of the present disclosure.

FIG. 4B shows a non-limiting example of a convolutional neural network (CNN), as in the present disclosure.

FIG. 5A shows a perspective view of a positron-emission tomography (PET) scanner, according to an embodiment of the present disclosure.

FIG. 5B shows a schematic view of a PET scanner, according to an embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The system may be otherwise oriented (rotated 90 degrees or at other orientations) and the spatially relative descriptors used herein may likewise be interpreted accordingly.

The order of discussion of the different steps as described herein has been presented for clarity sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

As part of a scanning system, additional equipment can be used to measure predetermined metrics of a patient in order to determine which data can include motion (and thus imaging errors) and which data can be more devoid of motion-induced imaging errors. For cardiac gating during a positron emission tomography (PET) or computed tomography (CT) scan, the use of electrocardiograms (ECG or EKG) can be relatively easy, cheap, and has been shown to be reproducible. Similar gating methods can be applied to other imaging modalities, such as X-ray, MRI, and the like. The EKG can also serve to monitor the patient during the scan. The acquired EKG signal can employ the R-wave as a reference to estimate the cardiac phase in which each coincidence was acquired, ultimately allowing the data to be sorted into cardiac gates, some which will have less motion. Notably, cardiac gating can generally be performed retrospectively, that is, after scan data has been acquired or obtained. In comparison, prospective gating can be used to control the scanning system during acquisitions.

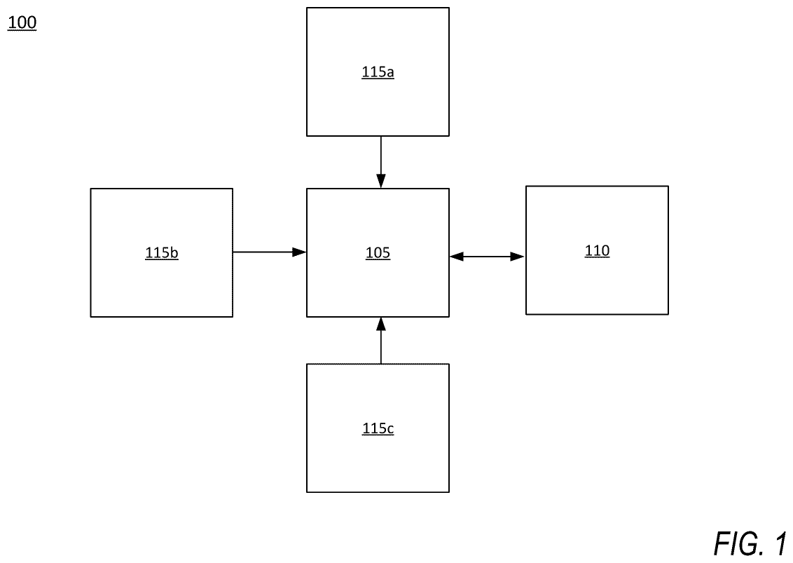

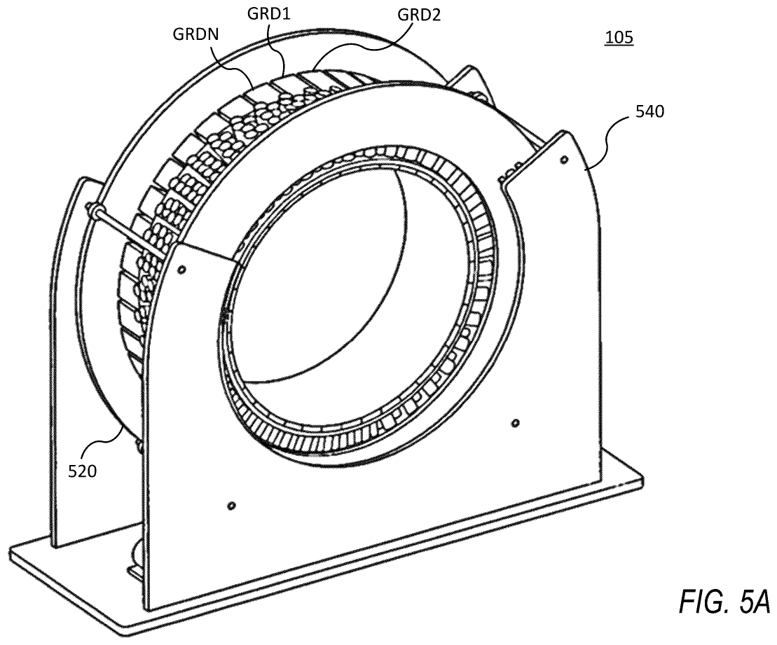

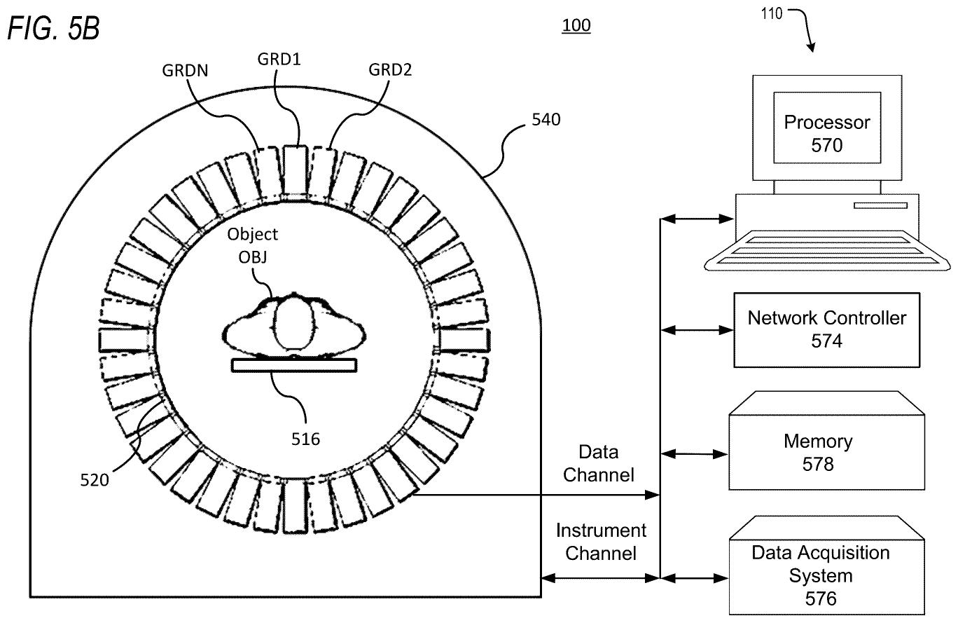

Referring now to the Drawings, FIG. 1 shows a block diagram of an imaging system 100, according to an embodiment of the present disclosure. In an embodiment, the imaging system 100 can be a PET imaging system and include a scanner 105, a processing device 110, and a patient comfort monitoring system 115 (herein referred to as “monitoring system 115”), wherein the scanner 105 is a PET scanner for a PET imaging system. The scanner 105, for the PET imaging system, can include detector crystals arranged in a ring around a central axis that are configured to detect gamma rays. The scanner 105 can include additional rings of detector crystals adjacent to one another and disposed along the axis of the rings. An object to be scanned can be arranged in the center of the detector crystals 105, such as a phantom or a human (patient). Scan data obtained by the scanner 105 can be transmitted to the processing device 110. The processing device 110 can be a device including processing circuitry configured to send data to and receive data from the scanner 105, as well as analyze said data. The processing device 110 can be, for example, a desktop computer, a laptop, a tablet, a smart phone, or a server, among others. Additional features of the scanner 105 and the processing device 110 are shown in FIGS. 5A and 5B and described in the accompanying description below. It may be appreciated that the scanner 105 can instead be a scanner for another imaging modality, such as CT, MRI, and X-ray, among others. Such a scanner can be configured to obtain scan data by detecting radiation corresponding to the particular imaging modality and transmit the scan data to the processing device 110. However, the scanner 105 as described herein will be referring to the PET imaging modality for illustrative purposes.

In an embodiment, the monitoring system 115 can include at least one monitoring device, such as a first monitoring device 115a, a second monitoring device 115b, and a third monitoring device 115c. Via the monitoring system 115, a patient emotional state can be generated and recorded by the scanner 105 during the PET data acquisition. The first monitoring device 115a, second monitoring device 115b, and third monitoring device 115c can be configured to measure a parameter or metric associated with the patient and transmit said parameter to the processing device 110, either via the scanner 105 (as shown) or directly. Notably, the first monitoring device 115a, second monitoring device 115b, and third monitoring device 115c can be configured to measure or monitor the patient parameter over an entirety of the scan or for a portion of the scan. The output from the first monitoring device 115a, second monitoring device 115b, and third monitoring device 115c can be recorded by the processing device 110.

In an embodiment, the emotional state data of the patient can be considered a patient comfort signal (PCS). In an embodiment, a technician (or technologist, or user) can be attending to the equipment (the imaging system 100) and instructing the patient during the scan. The PCS can be interpreted by the technician or by an AI algorithm. The result can be fed to the technician via a variety of methods, including pager, text, alarm, or a message on the operator console, among others. Upon determining the patient's emotion changes sufficiently to necessitate intervention, the technician can attend to the patient. The range of emotions that can be readily detected are, for example, i) the patient being too hot or too cold, ii) the patient showing signs of distress or anxiety, and iii) the patient showing signs of distraction during a focused cognitive study. Further, the appropriate intervention can be based on the imaging scenario and the detected emotion. For example, for a step-and-shoot whole-body PET scan where the patient discomfort is detected, the technician can tell the patient to try to remain motion-less until the end of the current sub-scan and then pause the scan (between bed positions) and attend to the patient's comfort. For example, in a cognitive study, the technician can decide to repeat parts of the scan or exam if unwanted emotional states are detected.

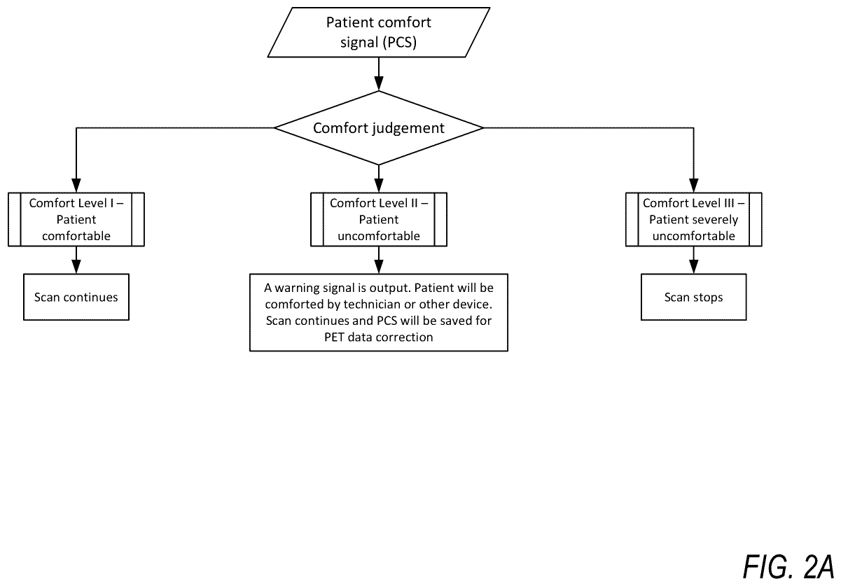

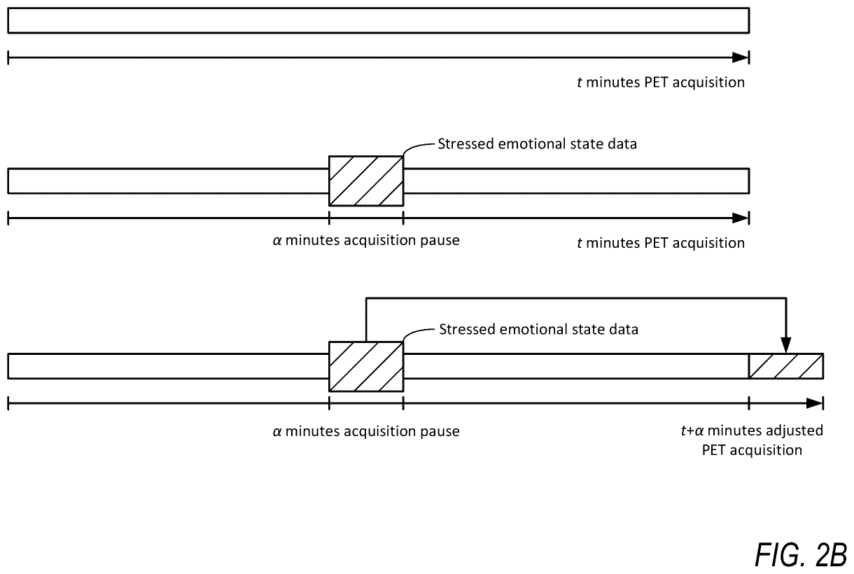

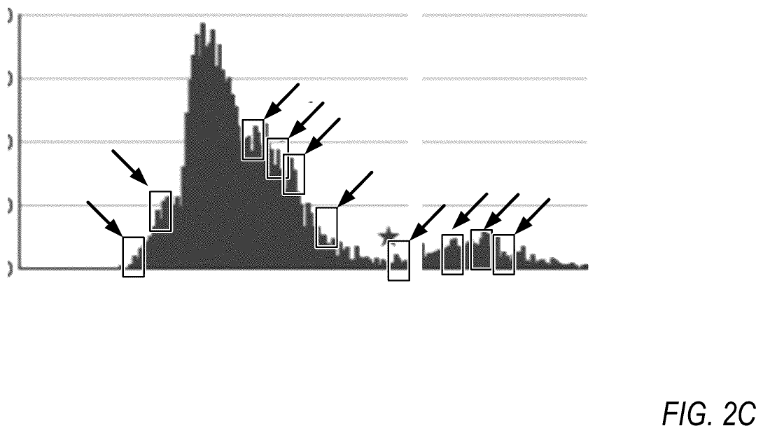

FIG. 2A is a schematic of the determination of a patient comfort level, according to an embodiment of the present disclosure. In an embodiment, the PCS can be generated by the monitoring system 115 and reviewed, to determine the patient comfort level, by the processing device 110 (see below) or the technician. Upon determining the patient comfort level indicates the patient is comfortable (e.g., a patient comfort level I), the scanner 105 can continue to perform the scan. For example, the processing device 110 can analyze the PCS and transmit a signal to instruct the scanner 105 to continue the scan. For example, the technician can analyze the PCS and instruct the scanner 105 to continue the scan by answering a prompt that the patient comfort level is sufficient to continue the scan. Upon determining the patient comfort level indicates the patient is mildly or moderately uncomfortable (e.g., a patient comfort level II), the scanner 105 can be paused. Further, when the scanner 105 is paused, a patient comforting process can be initiated to try and decrease the discomfort or stress the patient is experiencing. For example, a warning signal can be output to alert the technician that the patient is uncomfortable and prompt the technician to choose a process or device to use and comfort the patient. For example, the processing device 110 can detect the scan has paused and initiate the patient comforting process, wherein a particular strategy to comfort the patient is based on the PCS, such as adjusting a temperature of the room or environment if the PCS indicates the patient is too hot or too cold.

FIG. 2B is a schematic of a scan length adjustment in response to a paused scan, according to an embodiment of the present disclosure. In an embodiment, the technician or the processing device 110 can pause the scanner 105 in response to determining the patient is mildly or moderately uncomfortable and log a length of time needed to comfort the patient in the stressed emotional state sufficiently to resume scanning. In an embodiment, the scan can continue even after the patient is determined to be mildly or moderately uncomfortable, and the length of time needed to comfort the patient in the stressed emotional state can be logged by the processing device 110. This can be particularly applicable for imaging modalities that have a longer total scan duration, such as MM. As shown, a scan protocol can include obtaining t minutes of scan data, such as PET list mode data. For example, the scan duration can be t=10 minutes, and the stressed emotional state for the patient can be detected and determined to last α=1 minute before the patient returns to a comfortable state. As such, an additional time of 1 minute can be added to the scan duration in order to obtain additional scan data to replace the 1 minute of scan data obtained while the patient was in the stressed emotional state.

In an embodiment, upon determining the patient comfort level indicates the patient is severely uncomfortable (e.g., a patient comfort level III), the scanner 105 can be immediately stopped. For example, the patient can be experiencing an episode of extreme emotional stress and unable to remain still or within a predetermined range of movement. In such an example, the warning signal or another warning signal indicating an escalation of attention required from the technician can be output to alert the technician to immediately intervene and provide rapid discomfort mitigation techniques for the patient. In order for the technician to provide the rapid discomfort mitigation techniques, the scanner 105 can immediately stop and initiate a patient egress procedure.

As previously described, the monitoring system 110 can generate the PCS data to monitor the patient emotional state and signal when intervention is needed to help the patient and improve data acquisition, analysis, and correction. In an example related to the cardiac gating for generating the PCS, the cardiac gating workflow can include a step where the PET (or CT) data can be acquired and the imaging system 100 includes an EKG system as the first monitoring device 115a that can be running at the same time. In such an example, EKG data is the PCS. As such, the scanner 105 or the processing device 110 can be recording the EKG data of the patient before, during, and/or after the scan. Upon obtaining the scan and the EKG data, a histogram of the heartbeat intervals can be generated including R-to-R intervals, which essentially describe the length or duration of one heartbeat of the patient. A patient can be in a calm state with a heartbeat that is steady at, for example, 60 beats per minute, which can correlate to a generated histogram having very consistent R-to-R intervals at the detected 60 beats per minute. Normally over the course of a single scan, which can range from, for example, a minute to 10 minutes, a distribution of different heartbeat rates can be observed. Often, this distribution can be bimodal and can correlate to i) the start of a scan where the patient is nervous or stressed and the heartbeat is fast and variable, and ii) after the start of the scan when the patient settles in and relaxes and the patient's heartbeat becomes less variable and also lower. Thus, in an example, the generated histogram from the full scan can include a tight distribution around, for example, 50 to 70 beats per minute and also a messy or less tight distribution of data or heartbeats at about 100 to 120 beats per minute that correlate to when the patient was nervous.

FIG. 2C is a schematic of a R-R histogram, according to an embodiment of the present disclosure. After the scan has completed, in order to generate an image, either i) the technician can analyze the histogram and select the portions of the histogram that correlate to the relaxed state of the patient, ii) the processing device 110 can use an automated process to determine and select the portions of the histogram that correlate to the relaxed state of the patient, or iii) the processing device 110 can use an automated process to determine the portions of the histogram that correlate to the relaxed state of the patient and suggest to the technician which portions to include or exclude for generating the image. The automated process can include a set identification method or a machine learning process. For example, the machine learning process can be an artificial neural network (ANN) that can be trained using a training data set and additional input from the reviewed data reviewed by the technician. The portions of the histogram that correlate to the relaxed state of the patient can be selected because the heartbeat is less variable, so the quality of the gating image can concomitantly be better.

Having a human review the data and select the portions of the data to use for image generation can identify some outlier data points wherein the patient is still nervous but the heartbeats are recorded or shown in the histogram as being slow during the transition. Such portions of the data can still lead to poor image generation, and as such, can be excluded. Identifying such portions of the data can be difficult using the automated process of the processing device 110, especially for an automated process that has set rules for identification. This can lead to missed identification of portions to exclude or include, and thus lead to degraded final image quality. The technician can, however, input the reviewed and corrected identification of the outlier data points as training data for the automated process (for an ANN) in order to improve the accuracy of the automated process. However, having the technician select the desired portions of data can, on the other hand, lead to human error contributions and variances in what the technician believes to be good or bad data. This can degrade the generated image quality instead of improving the quality.

Furthermore, while the rate of the heartbeat can be monitored and measured, the analysis and selection of data are limited to the single parameter. To this end, the automated process can also be applied to another gating method, such as data driven respiratory gating (DDRG), which can also be a retrospective gating method. In an embodiment, for DDRG, the patient can be on a table of the scanner 105 and the second monitoring device 115b can be a respiratory gating device. The second monitoring device 115b can include a belt, optical sensor (e.g., a laser), or other device to measure a parameter or parameters of the patient's chest, such as a displacement over time. The measured parameter or PCS, such as the chest motion, can be represented as a waveform, which can be acquired at the same time as the scan data and correlated to images at specific times. That is, an event stream can be generated that associates each event (and thus, each image at each specific time) with the data from the monitoring device 115, such as the measured chest motion, EKG data, etc. This event stream can be analyzed by the processing device 110.

In an embodiment, the processing device 110 can analyze the PET event stream and sort the event stream into different portions of the patient's breathing cycle. This can yield, for example, ten minutes of scan data sorted into two or four or ten images that correlate to the patient breathing in, breathing out, halting chest motion at the end of an inhale, halting chest motion at the end of an exhales, etc. Each of the images generated correlating to the different portions of the patient's breathing cycle, especially the images correlating to the halting chest motions, can yield a crisper, higher quality image. However, DDRG and respiratory gating in general can have accuracy issues due to varying unique chest motions for each patient. This can be partially accounted for by performing a calibration and teaching the patient how to optimally breathe during the scan, but often the opportunity to calibrate is unavailable and the patient may not be able to stay in the calm state. Moreover, the patients that are being scanned can have varying levels of health, wherein the consistent breathing pattern can be easier for a healthy patient to sustain while being more difficult for patients with illnesses, especially illnesses affecting the lungs. As such, some patterns of breathing in the calm state for an ill patient can be mistaken for a stressed breathing pattern. For example, maintaining the consistent breathing pattern for a patient who is obese can be difficult. For example, maintaining the consistent breathing pattern for a patient with lung cancer can be difficult, and the more accurate scan would be especially beneficial for this particular patient to detect the cancer earlier or image the affected regions in preparation for surgery.

Thus, described herein is a method for augmenting or replacing the device-based gating that can determine or identify the patient calm state data from the patient stressed state data by analyzing the monitored parameters of the patient. Again, with cardiac gating, the patient's heartbeat can speed up and slow down, but the actual heartbeat itself (i.e., the electrical signal), almost always appears the same. By analyzing the parameters of the chest instead, additional information can be determined. In particular, an emotional state assessment method can analyze the chest parameter data and determine the emotional state or PCS of the patient and input this emotional state determination into the ANN as training data.

Notably, the breathing of the patient can be analyzed further by identifying different types of breathing that are presented in the monitored parameter data. This can be, as previously described, in addition to the identified breathing motions (inhaling, exhaling, halting chest motion after inhaling, halting chest motion after exhaling, etc.). For example, while the patient heartbeat and the breathing pattern can be labeled as “fast” to identify a stressed state, the patient can attempt to reduce his/her heartbeat by breathing slower. However, this does not mean the patient is suddenly in the calm state as the data would indicate, and as much as the patient attempts to remain calm, the patient's breathing pattern can be different from the patient's true calm state breathing pattern. Additional information can be extracted from the breathing data and labeled based on known or previously analyzed breathing patterns. The important information may not be so much the timing of the breaths or the respiration rate as it was with the heartbeat rate, but rather the shape of the breathing motion (the measured waveform).

In an embodiment, breathing in and breathing out can be measured (e.g., by a camera and/or computer vision system) by more than just the time between breaths. The shape of the measured waveform can change greatly. When a patient is relaxed, prior to taking the next breath, the patient can maintain an exhaled state for a duration after performing the exhale. When a patient is nervous, the patient can breathe shallow at the top near inhalation every four or five breaths, like waves in the ocean, and then perform a deep exhale and inhale. Notably, these behaviors can be subconscious and difficult for the patient to control but are directly detectable (e.g., by a technician, a camera, and/or a computer vision system), thus presenting data that is more likely to be correlated with the true patient emotional state. The breathing pattern can be detected by the automated process, such as the ANN, and identified or labeled as such for segmentation prior to image generation. Alternatively, the technician can instead or in combination with the ANN identify or label the breathing pattern for segmentation prior to image generation. There are additional different patterns that the ANN can try to cluster around, but the ANN does not have any outside information about doing that. As such, accurate training data can be input to train the ANN over time. Upon further training, the ANN can more accurately segment the scan data into data representing the calm state and the stressed state of the patient. The determination or segmentation by the ANN can be used to generate images with higher quality automatically, or again, the processing device 110 can output the results from the ANN and the automated process to the technician for the technician to perform a final review of the suggestions before generating the final reconstructed based on the segmented data. It may be appreciated that by iterating the training, the ANN can become more robust and less error prone.

Additional monitoring devices can be used to monitor additional patient parameters, further determine the patient emotional state, and identify the data to use for generating the final reconstructed image. In an embodiment, the third monitor device 115c can be a camera, such as a charge-coupled device (CCD), near-infrared (NIR), or Forward Looking InfraRed (FLIR), camera, among others. The camera can be configured to obtain an image or video of the patient, such as an optical or IR image or video data feed. It may be appreciated that the CCD camera can have a filter attachment configured to filter out the visible wavelengths of light to produce an IR image. The camera can be gantry- or wall-mounted. To convert camera images or video to PCS, color (e.g., RGB) video data can optionally be transmitted (e.g., streamed with timestamps) to the processing device 110 including an emotion monitoring software application that can analyze the video data. The monitoring system 115 can also produce data (emotional state or states) which can be incorporated into a data stream of a connected medical imaging system and which can be synchronized with the streamed video.

In an embodiment, the patient's forehead temperature or cheek temperature can be both easy to measure because the face is exposed and also closely correlated to anxiety or stress. As such, the temperature parameter can be recorded at the same time as the scan data and any other parameters being monitored, such as the EKG and the breathing motion of the patient, among others. For example, the patient can be feeling anxious at the start of the scan and have a corresponding increase in body temperature. Upon relaxing, the patient's body temperature can decrease and the processing device 110 can segment the data at the start of the scan from the relaxed state data of the scan based on the decreased temperature.

In an embodiment, the third monitoring device 115c can be an audio recording device configured to record audio from the patient. For example, the patient can experience discomfort and thus can make an audible noise, such as a grunt or noise from repositioning in the scanner 105. The recorded audio can be obtained at the same time as the scan data and used to mark or flag data that was obtained during the stressed state. For example, the technician can request the patient to periodically answer a question or repeat a predetermined set response that is recorded by audio recording device. The processing device 110 can analyze a rhythm or regularity of the patient's speech when answering the question or repeating the response and determine whether the patient is in the calm state or the stressed state during the scan. The recorded audio can be obtained at the same time as the scan data and used to mark or flag data that was obtained during the stressed state, but also mark or flag data that was obtained when the patient's speech rhythm improved and corresponded to a more relaxed state.

In an embodiment, the third monitoring device 115c can be a force feedback device including a force transducer configured to receive a mechanical input or force feedback from the patient. For example, the force transducer can be integrated into a stress ball comprised of a compressible and elastic material, such as a polymer foam rubber. The force transducer can be configured to receive the mechanical input from the patient via, for example, the patient squeezing the stress ball. The mechanical input can be converted to an electrical signal that is recorded at the same time as the scan data and transmitted to the scanner 105 and/or the processing device 110. Higher mechanical input (relative to a baseline grip force) can correspond to pain or discomfort in the patient, while little to no mechanical input can correspond to the relaxed state. In an embodiment, the squeezing of the stress ball (and thus the force transducer) can be a subconscious reflex by the patient when stressed that presents another source of data that is less fungible and more likely to be correlated with the true patient emotional state.

In an embodiment, to acquire deviceless PCS during PET data acquisition, a fast reconstruction or sinogram for each small timing frame (0.5 or 1 second) can be generated. The covariance of the two consecutive frames can be calculated. When the patient is uncomfortable and the data acquisition is disturbed, a larger covariance can be expected.

In an embodiment, any of the above examples can be used in combination with the aforementioned automated process in order to segment the data more accurately and further train the ANN. For example, the patient can be undergoing a scan with what appears to be a consistent heartbeat rate indicative of being in a relaxed state. However, using the force feedback device, the mechanical input during the same time frame of scanning can indicate the patient was in pain due to a high force feedback. As such, even though the patient demonstrated a consistent heartbeat, the patient may have been tightening some muscles to cope with any felt pain which would yield decreased scan data quality. This can be flagged as data to be segmented out from the data used for generating the final reconstructed image. Since there are disagreeing conclusions regarding the patient emotional state, the data may be segmented but not discarded entirely.

In an embodiment, additional forms of confirmation can be used, such that two or more sources of parameter monitoring are used. Building on the same example, the ANN can analyze the same scan data for the same segment of data that was flagged as being when the patient was experiencing discomfort or stress. The ANN can analyze, in the same segment of data, the recorded breathing pattern of the patient and determine that the breathing pattern exhibited a pattern of consistent short shallow breaths followed by a deep breath, thus indicating the patient in the stressed state. This can confirm the conclusion by the force feedback device and the data, which was previously determined to be inconclusive, can now be labeled as data to be discarded entirely. This conclusion and corresponding data set can be fed back into the ANN to train the ANN further and increase its robustness and accuracy.

In an embodiment, for the patient experience the patient comfort level II (mild to moderate discomfort), the data acquisition can continue and a retrospective data correction method using the PCS can be applied. A first data correction method can include removing the data acquisition corresponding to the unformattable PCS from the data set for the final PET reconstruction. A second data correction method can include regrouping the acquired PET data according to the obtained PCS data and reconstructing each new group separately.

As previously mentioned, the calibration of scan parameters for each patient can be difficult when the scan preparation and duration are short. Furthermore, while the scan settings for the imaging system 100 can be similar across multiple systems, the environment in which the imaging system 100 is installed or disposed can vary greatly. Therefore, a calibration for one patient in one location (such as a hospital) can be very different from a calibration for one patient in a completely different location (such as a university lab). Further, even within a single scan, a visual calibration to determine any visual cues corresponding to the patient's emotional state can be difficult to obtain in the event the technician, for example, lowers the lighting for the patient during the scan. In such an event, any calibration data obtained at the start of the scan may be no longer useful. Therefore, a calibration method performed in a controlled environment is described herein.

In an embodiment, especially for scanning methods that include a longer preparation time, the patient can be monitored in a controlled preparation environment during the preparation prior to performing the scan. In PET or PET-SPECT, the patient may be required to wait for 30 minutes or more before they can be scanned, such as after receiving a radioactive drug. During the 30 or more minutes, one or more of the monitoring devices 115a, 115b, 115c can obtain patient emotional state calibration data in the controlled preparation environment, wherein the controlled preparation environment can include a lighting level and temperature that is standardized across all patients. The 30 minutes, or even 10 minutes, can be sufficient time to obtain, for example, a camera video feed and run a retraining neural network. For example, a Targeted Gradient Descent (TGD) neural network can be already trained a predetermined amount and the extra calibration data can be used to further train the TGD neural network in real-time, which allows the TGD neural network to refine itself to better match a specific type of data. In this case, the specific type of data is the specific patient's emotional state based on their visible appearance, which can help segment the scan data after the scan if the same visual data is obtained during the scan. In an embodiment, the emotional state can also be used to control the scanner 105. Similarly, in PET, the patient may be positioned on the gantry of the scanner 105 for 10 or more minutes as the technician prepares the imaging system 100, during which time the camera video feed can be analyzed and used as the training data for the TGD neural network.

In an embodiment, the calibration data can include a predicted emotional state of the patient based on their medical history or demographic information. The different relevant patient information categories can fall under different classifiers for training the ANN. For example, the patient can be a stage I cancer patient and the patient medical history can be used as part of the training of the ANN. Notably, the medical records for the patient can be pulled from the hospital records or records from multiple different hospitals. The patient at stage I of cancer may be able to tolerate more pain and exhibit fewer incidents of the stressed emotional state during the scan. The patient at stage IV of cancer might not be able to tolerate as much pain and exhibits more frequent incidents of the stressed emotional state during the scan. For example, the patient can be in a predetermined age group and the relevant patient information can be used as part of the training of the ANN. For example, the patient can be older than 80 years old and exhibit more emotion in general than a patient (or the same patient previously) that is 65 years old. The various parameters and classifiers can be used to adjust settings of the scan, such as a sensitivity to halting the scan, and the data analysis, such as a threshold for identifying a particular feature in the data as indicative of a stressed emotional state.

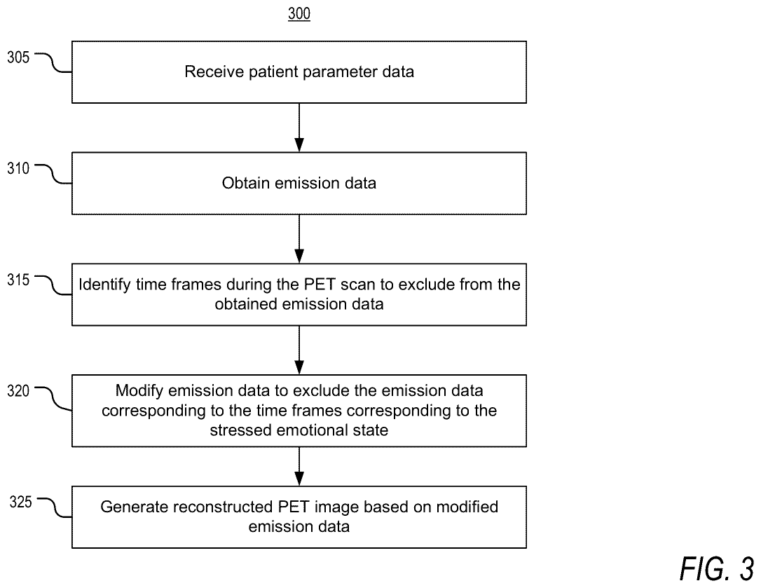

FIG. 3 shows a non-limiting example of a flow chart for a method 300 of generating an image, according to an embodiment of the present disclosure. In an embodiment, and with reference to the description above, in step 305, the time dependent data corresponding to the patient parameter or the PCS can be received or obtained, such as by the processing device 110. In step 310, the emission data representing gamma rays detected at a plurality of detector elements during the PET scan can be obtained. In step 315, time frames during the PET scan to exclude from the obtained emission data can be identified, the identified time frames corresponding to the stressed emotional state for the patient based on the patient parameter. For example, the machine learning model can be applied to the patient parameter data to identify time frames during the PET scan to exclude from the obtained emission data. For example, the technician can identify the time frames during the PET scan to exclude from the obtained emission data. In step 320, when a machine learning model can be applied, the obtained emission data can be modified based on an output of the machine learning model, the output of the machine learning model being the time frames identified within the patient parameter data as corresponding to the stressed emotional state for the patient. In step 325, a reconstructed PET image can be generated based on the modified emission data excluding the emission data corresponding to the time frames corresponding to the stressed emotional state.

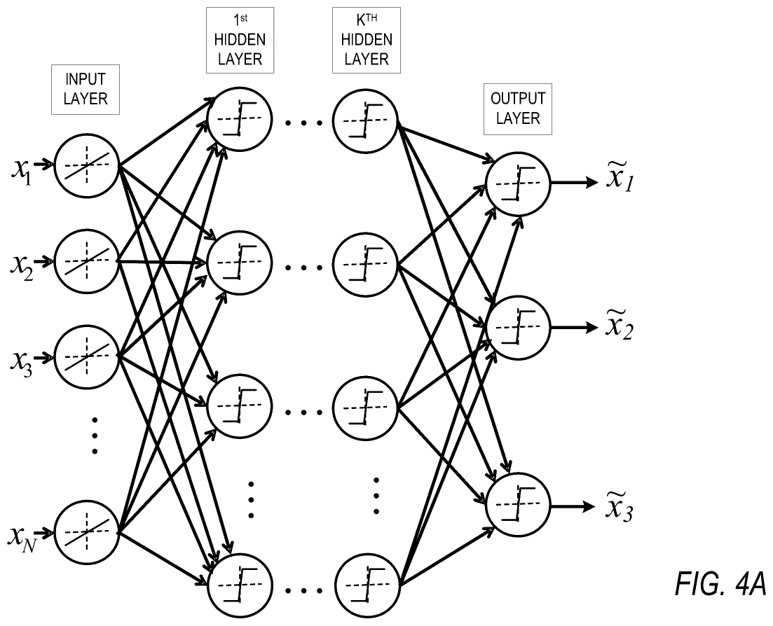

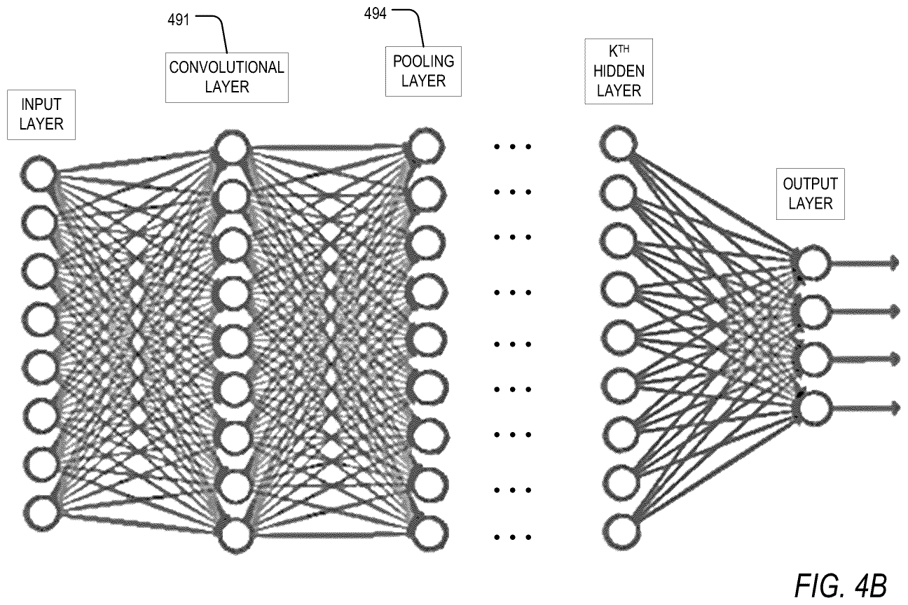

FIG. 4A and FIG. 4B show examples of the inter-connections between layers in a convolutional neural network (CNN), according to an embodiment of the present disclosure. In an embodiment, the CNN can include fully connected, convolutional, pooling, batch normalization, and activation layers, all of which are explained above and below. In certain preferred implementations of the CNN, convolutional layers are placed close to the input layer, whereas fully connected layers, which perform the high-level reasoning, are placed further down the architecture towards the loss function. Pooling layers can be inserted after convolutions and provide a reduction lowering the spatial extent of the filters, and thus the amount of learnable parameters. Batch normalization layers regulate gradient distractions to outliers and accelerate the learning process. Activation functions are also incorporated into various layers to introduce nonlinearity and enable the network to learn complex predictive relationships. The activation function can be a saturating activation function (e.g., a sigmoid or hyperbolic tangent activation function) or rectified activation function.

FIG. 4A shows an example of a general artificial neural network (ANN) having N inputs, K hidden layers, and three outputs. Each layer is made up of nodes (also called neurons), and each node performs a weighted sum of the inputs and compares the result of the weighted sum to a threshold to generate an output. ANNs make up a class of functions for which the members of the class are obtained by varying thresholds, connection weights, or specifics of the architecture such as the number of nodes and/or their connectivity. The nodes in an ANN can be referred to as neurons (or as neuronal nodes), and the neurons can have inter-connections between the different layers of the ANN system. The simplest ANN has three layers and is called an autoencoder. The CNN of the present disclosure can have more than three layers of neurons and have as many output neurons \tilde{x}_{N} as input neurons, wherein Nis the number of, for example, pixels in the training image. The synapses (i.e., the connections between neurons) store values called “weights” (also interchangeably referred to as “coefficients” or “weighting coefficients”) that manipulate the data in the calculations. The outputs of the ANN depend on three types of parameters: (i) the interconnection pattern between the different layers of neurons, (ii) the learning process for updating the weights of the interconnections, and (iii) the activation function that converts a neuron's weighted input to its output activation.

Mathematically, a neuron's network function m(x) is defined as a composition of other functions nᵢ(x), which can be further defined as a composition of other functions. This can be conveniently represented as a network structure, with arrows depicting the dependencies between variables, as shown in FIG. 4A and FIG. 4B. For example, the ANN can use a nonlinear weighted sum, wherein m(x)=K(Σᵢwᵢnᵢ(x)) and where K (commonly referred to as the activation function) is some predefined function, such as the hyperbolic tangent.

In FIG. 4A (and similarly in FIG. 4B), the neurons (i.e., nodes) are depicted by circles around a threshold function. For the non-limiting example shown in FIG. 4A, the inputs are depicted as circles around a linear function and the arrows indicate directed communications between neurons. In certain implementations, the CNN is a feedforward network.

The CNN of the present disclosure operates to achieve a specific task by searching within the class of functions F to learn, using a set of observations, to find m*∈F, which solves the specific task in some optimal sense (e.g., the stopping criteria used in step 885 discussed above). For example, in certain implementations, this can be achieved by defining a cost function C:F→m such that, for the optimal solution m*, C(m*)≤C(m)∀m∈F (i.e., no solution has a cost less than the cost of the optimal solution). The cost function C is a measure of how far away a particular solution is from an optimal solution to the problem to be solved (e.g., the error). Learning algorithms iteratively search through the solution space to find a function that has the smallest possible cost. In certain implementations, the cost is minimized over a sample of the data (i.e., the training data).

FIG. 4B shows a non-limiting example of a convolutional neural network (CNN), as in the present disclosure. CNNs are a type of ANN that have beneficial properties for image processing and, therefore, have special relevancy for applications of image processing. CNNs use feedforward ANNs in which the connectivity pattern between neurons can represent convolutions in image processing. For example, CNNs can be used for image-processing optimization by using multiple layers of small neuron collections which process portions of the input image, called receptive fields. The outputs of these collections can then be tiled so that they overlap to obtain a better representation of the original image. This processing pattern can be repeated over multiple layers having convolution 491 and pooling layers 494, as shown, and can include batch normalization and activation layers.

As generally applied above, following after a convolution layer 491, a CNN can include local and/or global pooling layers 494 which combine the outputs of neuron clusters in the convolution layers. Additionally, in certain implementations, the CNN can also include various combinations of convolutional and fully connected layers, with pointwise nonlinearity applied at the end of or after each layer.

CNNs have several advantages for image processing. To reduce the number of free parameters and improve generalization, a convolution operation on small regions of input is introduced. One significant advantage of certain implementations of CNNs is the use of shared weight in convolution layers, which means that the same filter (weights bank) is used as the coefficients for each pixel in the layer, both reducing memory footprint and improving performance. Compared to other image processing methods, CNNs advantageously use relatively little pre-processing. This means that the network is responsible for learning the filters that in traditional algorithms were hand-engineered. The lack of dependence on prior knowledge and human effort in designing features is a major advantage for CNNs.

FIGS. 5A and 5B show a non-limiting example of the scanner 105 that can implement the method 300. The scanner 105 includes a number of gamma-ray detectors (GRDs) (e.g., GRD1, GRD2, through GRDN) that are each configured as rectangular detector modules. According to one implementation, the detector ring includes 40 GRDs. In another implementation, there are 48 GRDs, and the higher number of GRDs is used to create a larger bore size for the scanner 105.

Each GRD can include a two-dimensional array of individual detector crystals, which absorb gamma radiation and emit scintillation photons. The scintillation photons can be detected by a two-dimensional array of photomultiplier tubes (PMTs) that are also arranged in the GRD. A light guide can be disposed between the array of detector crystals and the PMTs.

Alternatively, the scintillation photons can be detected by an array a silicon photomultipliers (SiPMs), and each individual detector crystals can have a respective SiPM.

Each photodetector (e.g., PMT or SiPM) can produce an analog signal that indicates when scintillation events occur, and an energy of the gamma ray producing the detection event. Moreover, the photons emitted from one detector crystal can be detected by more than one photodetector, and, based on the analog signal produced at each photodetector, the detector crystal corresponding to the detection event can be determined using Anger logic and crystal decoding, for example.

FIG. 5B shows a schematic view of a PET scanner system having gamma-ray (gamma-ray) photon counting detectors (GRDs) arranged to detect gamma-rays emitted from an object OBJ. The GRDs can measure the timing, position, and energy corresponding to each gamma-ray detection. In one implementation, the gamma-ray detectors are arranged in a ring, as shown in FIGS. 5A and 5B. The detector crystals can be scintillator crystals, which have individual scintillator elements arranged in a two-dimensional array and the scintillator elements can be any known scintillating material. The PMTs can be arranged such that light from each scintillator element is detected by multiple PMTs to enable Anger arithmetic and crystal decoding of scintillation event.

FIG. 5B shows an example of the arrangement of the scanner 105, in which the object OBJ to be imaged rests on a table 516 and the GRD modules GRD1 through GRDN are arranged circumferentially around the object OBJ and the table 516. The GRDs can be fixedly connected to a circular component 520 that is fixedly connected to the gantry 540. The gantry 540 houses many parts of the PET imager. The gantry 540 of the PET imager also includes an open aperture through which the object OBJ and the table 516 can pass, and gamma-rays emitted in opposite directions from the object OBJ due to an annihilation event can be detected by the GRDs and timing and energy information can be used to determine coincidences for gamma-ray pairs.

In FIG. 5B, circuitry and hardware are also shown for acquiring, storing, processing, and distributing gamma-ray detection data. The circuitry and hardware include: a processor 570, a network controller 574, a memory 578, and a data acquisition system (DAS) 576. The PET imager also includes a data channel that routes detection measurement results from the GRDs to the DAS 576, the processor 570, the memory 578, and the network controller 574. The DAS 576 can control the acquisition, digitization, and routing of the detection data from the detectors. In one implementation, the DAS 576 controls the movement of the bed 516. The processor 570 performs functions including reconstructing images from the detection data, pre-reconstruction processing of the detection data, and post-reconstruction processing of the image data, as discussed herein.

The processor 570 can be configured to perform various steps of methods described herein and variations thereof. The processor 570 can include a CPU that can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog, or any other hardware description language and the code may be stored in an electronic memory directly within the FPGA or CPLD, or as a separate electronic memory. Further, the memory may be non-volatile, such as ROM, EPROM, EEPROM or FLASH memory. The memory can also be volatile, such as static or dynamic RAM, and a processor, such as a microcontroller or microprocessor, may be provided to manage the electronic memory as well as the interaction between the FPGA or CPLD and the memory.

Alternatively, the CPU in the processor 570 can execute a computer program including a set of computer-readable instructions that perform various steps of the method(s) described herein, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xenon processor from Intel of America or an Opteron processor from AMD of America and an operating system, such as Microsoft VISTA, UNIX, Solaris, LINUX, Apple, MAC-OS and other operating systems known to those skilled in the art. Further, CPU can be implemented as multiple processors cooperatively working in parallel to perform the instructions.

The memory 578 can be a hard disk drive, CD-ROM drive, DVD drive, FLASH drive, RAM, ROM or any other electronic storage known in the art.

The network controller 574, such as an Intel Ethernet PRO network interface card from Intel Corporation of America, can interface between the various parts of the PET imager. Additionally, the network controller 574 can also interface with an external network. As can be appreciated, the external network can be a public network, such as the Internet, or a private network such as an LAN or WAN network, or any combination thereof and can also include PSTN or ISDN sub-networks. The external network can also be wired, such as an Ethernet network, or can be wireless such as a cellular network including EDGE, 4G and 4G wireless cellular systems. The wireless network can also be WiFi, Bluetooth, or any other wireless form of communication that is known.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

Embodiments of the present disclosure may also be as set forth in the following parentheticals.
(1) An apparatus, including: processing circuitry configured to receive, via a monitoring device, time-dependent data corresponding to a patient parameter, obtain emission data representing radiation detected during a medical imaging scan, identify time frames during the medical imaging scan to exclude from the obtained emission data, the identified time frames corresponding to a stressed emotional state for the patient based on the patient parameter, modify the obtained emission data to exclude the emission data corresponding to the time frames corresponding to the stressed emotional state, and generate an emotional-state-corrected image based on the modified emission data excluding the emission data corresponding to the time frames corresponding to the stressed emotional state.
(2) The apparatus of (1), wherein the obtained emission data comprises gamma rays detected at a plurality of detector elements during a positron emission tomography (PET) scan.
(3) The apparatus of (2), wherein the processing circuitry is further configured to identify the time frames during the PET scan to exclude from the obtained emission data by applying a machine learning model to the received patient parameter data.
(4) The apparatus of (3), wherein the processing circuitry is further configured to modify the obtained emission data based on an output of the machine learning model, the output of the machine learning model being the time frames identified within the patient parameter data as corresponding to the stressed emotional state for the patient.
(5) The apparatus of either (3) or (4), wherein the machine learning model includes a neural network trained on reference patient parameter data and corresponding reference emission data identified as corresponding to the stressed emotional state for the patient.
(6) The apparatus of any one of (3) to (5), wherein the machine learning model includes a neural network trained on patient parameter data obtained before the obtaining the emission data, the patient parameter data being reference data corresponding to a relaxed emotional state for the patient.
(7) The apparatus of any one of (3) to (6), wherein the patient parameter is a chest motion of the patient, the machine learning model is configured to identify a breathing pattern in the patient parameter data, the machine learning model identifies at least one breathing motion from the breathing pattern, and the processing circuitry is further configured to generate a corresponding reconstructed PET image corresponding to each of the at least one breathing motion identified from the breathing pattern.
(8) The apparatus of any one of (1) to (7), wherein the processing circuitry is further configured to obtain the emission data by stopping the obtaining of the emission data by a user based on the received time-dependent data corresponding to the patient parameter.
(9) The apparatus of any one of (1) to (8), wherein the monitoring device includes a force feedback device configured to receive a mechanical input from the patient, and the patient parameter is a force, the force being an electrical signal converted from the mechanical input from the patient.
(10) The apparatus of any one of (1) to (9), wherein the monitoring device includes a camera configured to obtain infrared data of the patient during the PET scan, and the patient parameter is a temperature of the patient.
(11) A method of generating an image, including: receiving, via a monitoring device, time-dependent data corresponding to a patient parameter; obtaining emission data representing radiation detected during a medical imaging scan; identifying time frames during the medical imaging scan to exclude from the obtained emission data, the identified time frames corresponding to a stressed emotional state for the patient based on the patient parameter; modifying the obtained emission data to exclude the emission data corresponding to the time frames corresponding to the stressed emotional state; and generating an emotional-state-corrected image based on the modified emission data excluding the emission data corresponding to the time frames corresponding to the stressed emotional state.
(12) The method of (11), wherein the obtained emission data comprises gamma rays detected at a plurality of detector elements during a positron emission tomography (PET) scan.
(13) The method of (12), further comprising identifying the time frames during the PET scan to exclude from the obtained emission data by applying a machine learning model to the received patient parameter data.
(14) The method of (13), further comprising modifying the obtained emission data based on an output of the machine learning model, the output of the machine learning model being the time frames identified within the patient parameter data as corresponding to the stressed emotional state for the patient.
(15) The method of either (13) or (14), wherein the machine learning model includes a neural network trained on reference patient parameter data and corresponding reference emission data identified as corresponding to the stressed emotional state for the patient.
(16) The method of any one of (13) to (15), wherein the machine learning model includes a neural network trained on patient parameter data obtained before the obtaining the emission data, the patient parameter data being reference data corresponding to a relaxed emotional state for the patient.
(17) The method of any one of (13) to (16), wherein the patient parameter is a chest motion of the patient, the machine learning model is configured to identify a breathing pattern in the patient parameter data, the machine learning model identifies at least one breathing motion from the breathing pattern, and the method further comprises generating a corresponding reconstructed PET image corresponding to each of the at least one breathing motion identified from the breathing pattern.
(18) The method of any one of (11) to (17), wherein the obtaining the emission data further comprises stopping the obtaining of the emission data by a user based on the received time-dependent data corresponding to the patient parameter.
(19) The method of any one of (11) to (18), wherein the monitoring device includes a force feedback device configured to receive a mechanical input from the patient, and the patient parameter is a force, the force being an electrical signal converted from the mechanical input from the patient.
(20) A non-transitory computer-readable storage medium including executable instructions, which when executed by circuitry, cause the circuitry to perform a method of generating an image, including: receiving, via a monitoring device, time-dependent data corresponding to a patient parameter; obtaining emission data representing radiation detected during a medical imaging scan; identifying time frames during the medical imaging scan to exclude from the obtained emission data, the identified time frames corresponding to a stressed emotional state for the patient based on the patient parameter; modifying the obtained emission data to exclude the emission data corresponding to the time frames corresponding to the stressed emotional state; and generating an emotional-state-corrected image based on the modified emission data excluding the emission data corresponding to the time frames corresponding to the stressed emotional state.
(21) An apparatus, including: processing circuitry configured to receive, via a monitoring device, time-dependent data corresponding to a patient parameter, obtain emission data representing gamma rays detected at a plurality of detector elements during a positron emission tomography (PET) scan, identify time frames during the PET scan to exclude from the obtained emission data, the identified time frames corresponding to a stressed emotional state for the patient based on the patient parameter, modify the obtained emission data to exclude the emission data corresponding to the time frames corresponding to the stressed emotional state, and generate a reconstructed PET image based on the modified emission data excluding the emission data corresponding to the time frames corresponding to the stressed emotional state.
(22) The apparatus of (1), wherein the monitoring device includes a camera configured to obtain optical images and another monitoring device includes an electrocardiogram (EKG) device configured to obtain EKG signal data to estimate the cardiac phase of the patient, and the identified time frames to exclude from the obtained emission data is based on the combination of the optical images and the EKG signal data.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. An apparatus, comprising:
processing circuitry configured to
receive, via a monitoring device, time-dependent data corresponding to a patient parameter,
obtain emission data representing radiation detected during a medical imaging scan,
identify time frames during the medical imaging scan to exclude from the obtained emission data, the identified time frames corresponding to a stressed emotional state for the patient based on the patient parameter,
modify the obtained emission data to exclude the emission data corresponding to the time frames corresponding to the stressed emotional state, and
generate an emotional-state-corrected image based on the modified emission data excluding the emission data corresponding to the time frames corresponding to the stressed emotional state.

2. The apparatus of claim 1, wherein the obtained emission data comprises gamma rays detected at a plurality of detector elements during a positron emission tomography (PET) scan.

3. The apparatus of claim 2, wherein the processing circuitry is further configured to identify the time frames during the PET scan to exclude from the obtained emission data by applying a machine learning model to the received patient parameter data.

4. The apparatus of claim 3, wherein the processing circuitry is further configured to modify the obtained emission data based on an output of the machine learning model, the output of the machine learning model being the time frames identified within the patient parameter data as corresponding to the stressed emotional state for the patient.

5. The apparatus of claim 3, wherein the machine learning model includes a neural network trained on reference patient parameter data and corresponding reference emission data identified as corresponding to the stressed emotional state for the patient.

6. The apparatus of claim 3, wherein the machine learning model includes a neural network trained on patient parameter data obtained before the obtaining the emission data, the patient parameter data being reference data corresponding to a relaxed emotional state for the patient.

7. The apparatus of claim 3, wherein
the patient parameter is a chest motion of the patient,
the machine learning model is configured to identify a breathing pattern in the patient parameter data,
the machine learning model identifies at least one breathing motion from the breathing pattern, and
the processing circuitry is further configured to generate a corresponding reconstructed PET image corresponding to each of the at least one breathing motion identified from the breathing pattern.

8. The apparatus of claim 1, wherein the processing circuitry is further configured to obtain the emission data by stopping the obtaining of the emission data by a user based on the received time-dependent data corresponding to the patient parameter.

9. The apparatus of claim 1, wherein the monitoring device includes a force feedback device configured to receive a mechanical input from the patient, and the patient parameter is a force, the force being an electrical signal converted from the mechanical input from the patient.

10. The apparatus of claim 1, wherein the monitoring device includes a camera configured to obtain infrared data of the patient during the PET scan, and the patient parameter is a temperature of the patient.

11. A method of generating an image, comprising:
receiving, via a monitoring device, time-dependent data corresponding to a patient parameter;
obtaining emission data representing radiation detected during a medical imaging scan;
identifying time frames during the medical imaging scan to exclude from the obtained emission data, the identified time frames corresponding to a stressed emotional state for the patient based on the patient parameter;
modifying the obtained emission data to exclude the emission data corresponding to the time frames corresponding to the stressed emotional state; and
generating an emotional-state-corrected image based on the modified emission data excluding the emission data corresponding to the time frames corresponding to the stressed emotional state.

12. The method of claim 11, wherein the obtained emission data comprises gamma rays detected at a plurality of detector elements during a positron emission tomography (PET) scan.

13. The method of claim 12, further comprising identifying the time frames during the PET scan to exclude from the obtained emission data by applying a machine learning model to the received patient parameter data.

14. The method of claim 13, further comprising modifying the obtained emission data based on an output of the machine learning model, the output of the machine learning model being the time frames identified within the patient parameter data as corresponding to the stressed emotional state for the patient.

15. The method of claim 13, wherein the machine learning model includes a neural network trained on reference patient parameter data and corresponding reference emission data identified as corresponding to the stressed emotional state for the patient.

16. The method of claim 13, wherein the machine learning model includes a neural network trained on patient parameter data obtained before the obtaining the emission data, the patient parameter data being reference data corresponding to a relaxed emotional state for the patient.

17. The method of claim 13, wherein
the patient parameter is a chest motion of the patient,
the machine learning model is configured to identify a breathing pattern in the patient parameter data,
the machine learning model identifies at least one breathing motion from the breathing pattern, and
the method further comprises generating a corresponding reconstructed PET image corresponding to each of the at least one breathing motion identified from the breathing pattern.

18. The method of claim 11, wherein the obtaining the emission data further comprises stopping the obtaining of the emission data by a user based on the received time-dependent data corresponding to the patient parameter.

19. The method of claim 11, wherein the monitoring device includes a force feedback device configured to receive a mechanical input from the patient, and the patient parameter is a force, the force being an electrical signal converted from the mechanical input from the patient.

20. A non-transitory computer-readable storage medium including executable instructions, which when executed by circuitry, cause the circuitry to perform a method of generating an image, comprising:
receiving, via a monitoring device, time-dependent data corresponding to a patient parameter;
obtaining emission data representing radiation detected during a medical imaging scan;
identifying time frames during the medical imaging scan to exclude from the obtained emission data, the identified time frames corresponding to a stressed emotional state for the patient based on the patient parameter;
modifying the obtained emission data to exclude the emission data corresponding to the time frames corresponding to the stressed emotional state; and
generating an emotional-state-corrected image based on the modified emission data excluding the emission data corresponding to the time frames corresponding to the stressed emotional state.
